(19) United States
(12) Patent Application Publication
(10) Pub. No.: US 2009/0016797 A1
(43) Pub. Date: Jan. 15, 2009

(54) Controlling tension in roll-based print media

(75) Inventors: Joaquim Brugue, Barcelona (ES); Sara Merida, Barcelona (ES); Eduardo Martin, Sabadell (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/822,944

(22) Filed: Jul. 11, 2007

(51) Int. Cl. B41J 15/04

(52) U.S. Cl. 400/613

(57) ABSTRACT

An apparatus, method and computer program for controlling the tension in roll-based print media. The apparatus comprises: an encoder arranged to detect an angular displacement of a roll of print media; a processing unit arranged to determine the radius of the roll of print media based on the detected angular displacement of the roll of print media; a motor arranged to apply torque to the roll of print media to create tension in the print media; and a controller arranged to control the torque applied by the motor based on the determined radius of the roll of print media.

### FIELD OF THE INVENTION

This invention relates to field of printing with roll-based print media, and more particularly to controlling tension in roll-based print media.

### BACKGROUND

Printers such as inkjet printers which print onto a variety of print media such as paper or film are well known. As well as accepting print media in a single sheet format, some printers also accept print media fed from a supply roll of print media. Such a printer may be typically referred to as a roll-based printer, being a printer that accepts roll-based print media.

It will be appreciated that, in order to achieve consistent print quality, it is important that feeding of the print media is finely controlled. Variation in print media speed or tension may result in deterioration of print quality in the form of, for example, a distorted image.

Accurate control of print media feeding from a roll is particularly problematic in wide-format printing (otherwise known as large format printing), where the width of the print media is large, for example 32 cm to 150 cm (or even more).

The feeding of print media from a roll for a large format printer is typically undertaken by means of a roller that advances the print media with a traction provided by pinch wheels. The print media is pulled from a roll that has a mechanism to provide some tension (back-tension) to the media. A conventional approach to providing such tension is to use friction to produce a resistance to the rotation of the roll.

Controlling the tension in the print media is of high importance. If the tension is too high the print media can slip from the traction of the roller, and even a small slippage can produce undesirable printing artifacts and reduce print quality. Conversely, if the tension is too low, the print media may not be properly guided and/or controlled and the position of the media may deviate laterally. Further, wrinkles in the print media may be created due to a mismatch in traction at different parts of the roller.

Some roll-based printers also retrieve the print media in a roll after printing, by extracting the print media from the printer and collecting it on a spindle. For the same reasons as feeding of print media to a printer, controlling the media tension is also important in the case of retrieving print media from a printer.

### BRIEF DESCRIPTION OF THE DRAWINGS

For a better understanding of the invention, embodiments will now be described, purely by way of example, with reference to the accompanying drawings, in which:

FIG. 1 is an illustration of a printer according to an embodiment of the invention;

FIG. 2 is a schematic section of a printer according to an embodiment of the invention;

FIG. 3 illustrates print media feed apparatus according to an embodiment of the invention;

FIG. 4 is an illustration of the gear train of the apparatus of FIG. 3; and

FIG. 5 is a schematic section of a printer according to an alternative embodiment of the invention.

### DETAILED DESCRIPTION OF THE INVENTION

According to an embodiment of the invention, there is provided a print media feed apparatus for controlling the tension in roll-based print media, the apparatus comprising: an encoder arranged to detect an angular displacement of the roll of print media; a processing unit arranged to determine the radius of the roll of print media based on the detected angular displacement of the roll of print media; a motor arranged to apply torque to the roll of print media to create tension in the print media; and a controller arranged to control the torque applied by the motor based on the determined radius of the roll of print media.

The radius of the roll of print media may be determined based on the ratio between a detected angular displacement of a roller and the detected angular displacement of the roll of print media.

Thus, there is provided a print media feed mechanism and method which can maintain substantially optimal tension in the print media as it is feed from a roll to a printer. Such an optimal back-tension may be bigger if the media width is bigger. In particular embodiments, the back-tension may be linearly increased with the media width. Such a mechanism and method may therefore be used to provide an optimal tension in print media fed to a large format printer.

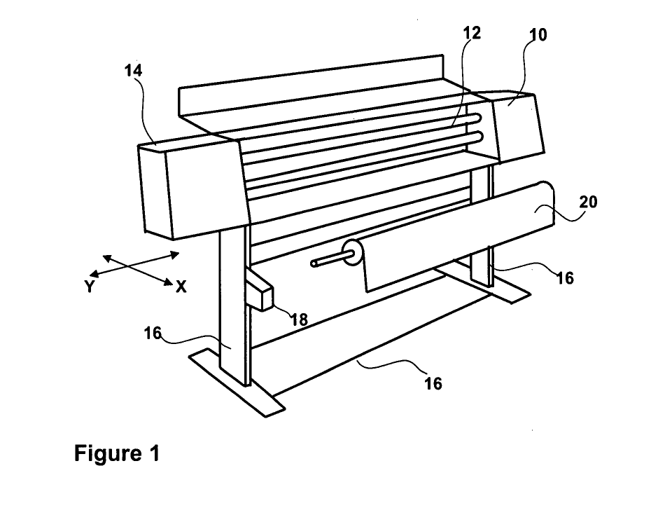

Referring to FIG. 1, a large format printer according to an embodiment comprises a printing unit 10 having a print head (not visible) which is adapted to reciprocate along a scan axis assembly 12 within a housing 14. The printing unit 10 is supported on a framework 16 so that it is raised up from a floor or surface upon which the framework 16 is positioned. The framework 16 comprises a supporting assembly 18 for rotatably supporting a supply roll of print media 20 such that print media may be fed from the supply roll 20 to the printing unit 10.

The print media 20, is fed along a media axis denoted as the X axis. A second axis, perpendicular to the X axis, is denoted as the Y axis. The print head reciprocates along a scan axis over print media 20 fed to the printer along, wherein the scan axis is parallel to the Y axis.

The supporting assembly 18 further comprises media feed apparatus (not visible) according to an embodiment of the invention. The media feed apparatus cooperates with the supply roll to control the tension in the print media 20 fed from the supply roll. In this example, a motor is coupled to the supply roll 20 via a gear train. Back-tension is provided by the motor applying a torque to the supply roll 20, wherein a controller controls the torque applied by the motor based on the radius of the roll of print media.

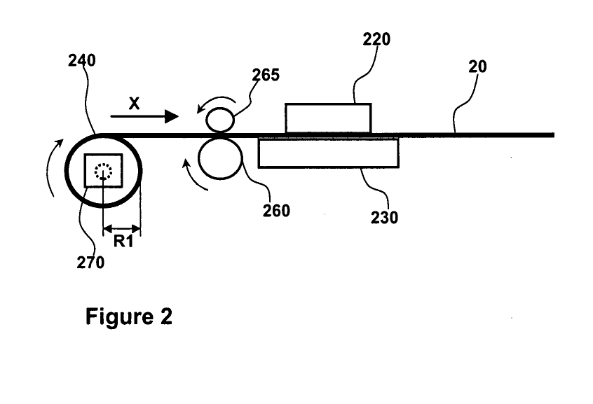

FIG. 2 schematically represents the print media 20 being fed to a printer between a printhead 220 and a platen 230. The print media 20 is extracted from a supply roll 240 and advances onto the platen 230. The direction of media advance is in the X direction or X axis. As the print media 20 pass between the printhead 220 and the platen 230, the printhead 220 reciprocates or scans along the media 20 along the Y direction or Y axis (which is in this case perpendicular to the X axis). More specifically, a drive roller 260 and pinch roller 265 arrangement is used to extract the print media from the supply roll 240. Here, the print media 20 is advanced due to friction/traction provided by the rotating drive roller 260 and pinch roller 265.

Coupled to the supply roll via a gear train (not visible) is a motor 270. The motor 270 comprises an encoder connected to a processing unit and a controller (otherwise referred to as a driver). The encoder is adapted to detect an angular displacement, such as angular position and angular velocity, of the supply roll 240 and the drive roller 260 as the media 20 is extracted from the supply roll 240. Based on the ratio of the detected angular displacements of the supply roll 240 and the drive roller 260, the processing unit determines the radius R1 of the supply roll 240.

Based on the determined radius R1 of the supply roll 240, the controller controls the motor to apply a torque to the supply roll to create tension in the print media. The amount of tension (i.e. the amount of torque applied by the motor) is controlled by supplying a voltage to the motor, which in turn supplies a torque to the supply roll spindle. The voltage supplied to the motor may be adjusted to compensate for the back ElectroMotive Force (EMF) of the motor (for example, the voltage may be increased/decreased by an amount proportional to the speed of the motor. Thus, the detected angular speed is used to compensate for the back EMF of the motor which is a voltage that grows linearly with the DC motor speed. To have a controlled mechanical tension in the supply roll, and therefore the media, the radius of the roll of print media is taken into account since spindle torque is equal to tension in the print media multiplied by the radius of the print media (i.e spindle torque=tension X radius), neglecting any friction.

Other factors may also be taken into account by the controller when controlling the amount of the torque applied by the motor. For example, the width of the print media 20 and/or the type of the print media 20 may be used. The media width is relevant as a wider media is pinched by more pinch wheels and therefore has a bigger traction capacity. It also requires more tension to correct its skew. It will be appreciated that information regarding the width and type of the print media 20 may be either detected automatically by the media feed apparatus or supplied to the controller by a user via a suitable interface.

It will be understood that the radius R1 of the supply roll 240 is proportional to the ratio between the distance advanced by the media 20 and the number of turns or angle of the supply roll. The values of the distance advanced and the number of turns can be precisely determined by the encoder. An initial value for the radius R1 of the supply roll 240 (i.e. a value of the radius when the supply roll is newly loaded to the printer) may be either detected automatically by the media feed apparatus or supplied to the controller by a user.

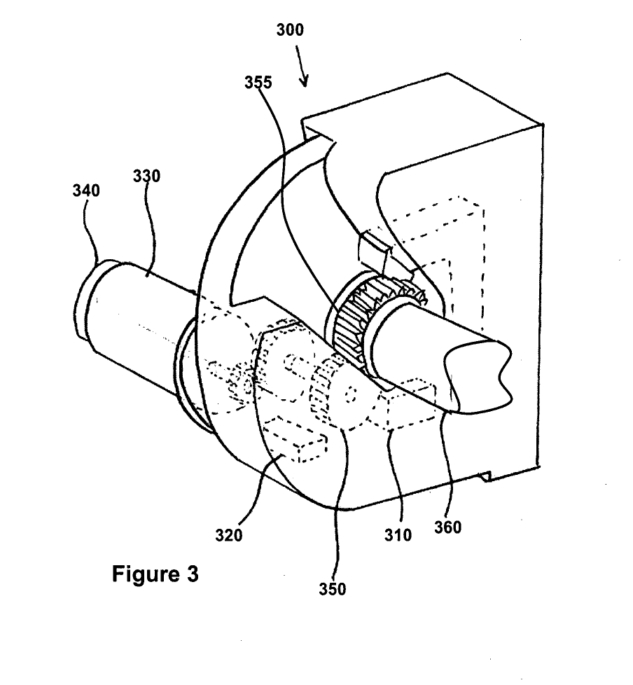

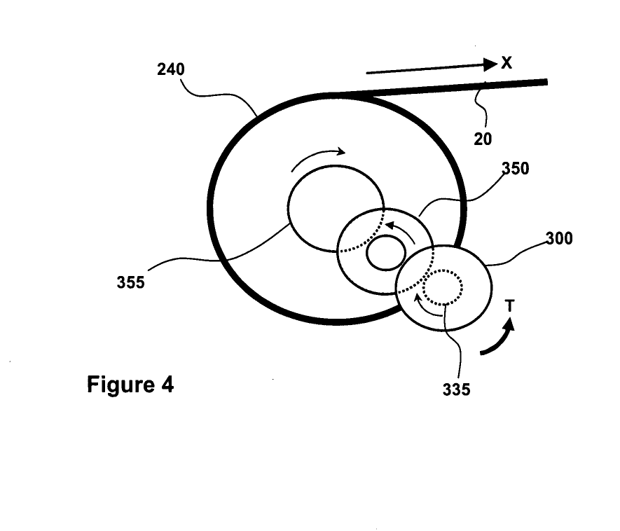

Referring now to FIGS. 3 and 4, a print media feed apparatus 300 according to an embodiment of the invention comprises a controller 310, a processing unit 320, a motor 330 and an encoder 340. The pinion 335 of the motor 330 drives a gear train 350 which in turn drives the gear 355 of a spindle 360, the spindle having a supply roll 240 of print media 20 placed thereon.

The encoder 340 is at the end of the motor 330 and is a disk attached to the motor's shaft and a module attached to the motor body. Further, although the controller 310 and processing unit 320 are illustrated as being within the assembly, they may be remotely located and connected to the motor 330 and encoder 340, through a power cable and a signal cable, respectively.

When print media is extracted from the supply roll, causing the spindle 360 to rotate, the encoder 340 detects the angular displacement of the spindle 360. Based on the detected angular displacement, the processing unit 320 determines the radius R1 of the roll of print media (by comparing a distance advanced by the media with the detected angular displacement of the spindle 360, for example). Using the determined value for the radius R1, the controller 310 controls the torque (as indicated generally by the arrow labeled “T”) applied to the spindle 360 by the motor 330 by controlling a voltage supplied to the motor 330. This supplied voltage is adjusted to compensate for the back EMF of the motor 330, by detecting the speed of the motor and estimating a back EMF correction voltage value.

It will be appreciated that the step of determining the radius R1 of the roll of print media might be periodically repeated every time media is extracted from the supply roll. In this way the accuracy and/or robustness of the calculated radius R1 may be improved. Preferably, the time period which elapses between repeating such steps will be small and the radius R1 determined regularly.

It is noted that embodiments may be arranged such that the motor 330 is able to apply sufficient torque to actually rewind the print media onto the supply roll. Such embodiments may therefore be used to help a user in the process of loading and/or unloading print media to a printer.

So far embodiments have been described which are arranged to control the tension in print media fed from a roll of print media to a printer. It should, however, be understood that alternative embodiments may also be arranged to control the tension in roll-based media fed from a printer to a roll of print media (i.e. print media extracted from a printer and collected on a spindle).

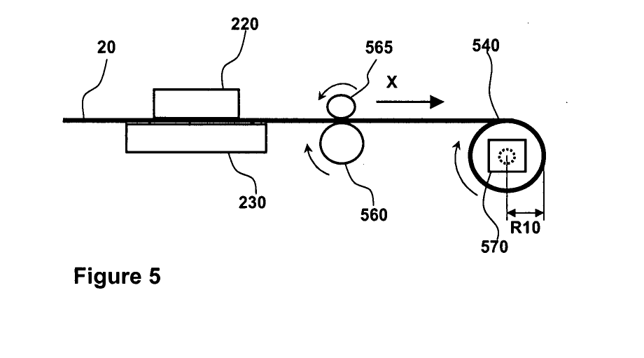

By way of example, FIG. 5 schematically represents the print media 20 being fed between a printhead 220 and a platen 230 of a printer to a roll 540 of print media 20 mounted on a spindle. The print media 20 is extracted from the printer and the direction of media advance is in the X direction or X axis. More specifically, a drive roller 560 and pinch roller 565 arrangement is used to extract the printer. Here, the print media 20 is advanced due to friction/traction provided by the rotating drive roller 560 and pinch roller 565.

Coupled to the supply roll via a gear train (not visible) is a motor 570. The motor 570 comprises an encoder connected to a processing unit and a controller. The encoder is adapted to detect an angular displacement, such as angular position and angular velocity, of the supply roll 540 and the drive roller 560 as the media 20 is extracted from the supply roll 540. Based on the detected angular displacements of the supply roll 540 and the drive roller 560, the processing unit determines the radius R10 of the supply roll 540.

Using the determined radius R10 of the supply roll 540, the controller controls the motor to apply a torque to the supply roll to create tension in the print media. The amount of tension (i.e. the amount of torque applied by the motor) is controlled by supplying a voltage to the motor, which in turn supplies a torque to the supply roll spindle.

Embodiments provide numerous advantages when compared to conventional media feeding concepts. Some if of these advantages may be summarized as follows.

Feeding and extraction of print media to and from a printer can be better controlled by maintaining an optimal amount of tension which takes into account factors including the width of the print media, the type of the print media, and the radius of the roll of print media.

Undesirably excessive values of tension in the print media can be avoided, thereby preventing image quality degradations (such as banding) caused by the print media suddenly slipping on the spindle.

Further, adversely low value of tension in the print media can also be circumvented so the print media does not wrinkle and/or skew (i.e. deviate from a desired orientation).

Embodiments provide a high degree of operating flexibility because the tension can be controlled to deal with media specific issues. For example, arrangement may be set up to maintain low tension in slippery print media, or to maintain higher tension in rigid media prone to jamming.

Alternative embodiments may also be used for rewinding the print media back onto the supply roll, which avoids a manual user operation and can be used to ensure that there is not a step in tension when a “bubble” or wrinkle of excess print media is eliminated and the media gets taught (this kind of step in the tension produces a specific printing artifact known as one-time banding).

An additional advantage related with the fact that the roll radius is known is that the print media length may be tracked and reported to a user. In this way, the user can be informed, for example, of whether or not there is enough print media available of the supply roll to complete a printing job.

While specific embodiments have been described herein for purposes of illustration, various modifications will be apparent to a person skilled in the art and may be made without departing from the scope of the invention.

1. Apparatus for controlling the tension in roll-based print media, the apparatus comprising:
an encoder arranged to detect an angular displacement of a roll of print media;
a processing unit arranged to determine the radius of the roll of print media based on the detected angular displacement of the roll of print media;
a motor arranged to apply torque to the roll of print media to create tension in the print media; and
a controller arranged to control the torque applied by the motor based on the determined radius of the roll of print media.

2. The apparatus of claim 1, wherein the apparatus is arranged to control the tension in roll-based print media fed from a roll of print media to a printer.

3. The apparatus of claim 1, wherein the apparatus is arranged to control the tension in roll-based media fed from a printer to a roll of print media.

4. The apparatus of claim 1 wherein the apparatus is further arranged to detect an angular displacement of a drive roller, and wherein the processing unit is further arranged to determine the radius of the roll of print media based on the detected angular displacement of the roll of print media and the detected angular displacement of the driver roller.

5. The apparatus of claim 1, wherein the controller is further arranged to control the torque applied by the motor based on the width of the print media.

6. The apparatus of claim 1, wherein the controller is arranged to control the torque applied by the motor by controlling an amount of voltage supplied to the motor.

6. The apparatus of claim 4, wherein the controller is arranged to adjust the amount of voltage supplied to the motor to compensate for the back electromotive force, EMF, of the motor.

7. The apparatus of claim 6, wherein the motor is a DC motor and the back EMF of the motor is determined based upon the angular speed of the motor.

8. The apparatus of claim 1, wherein the motor is adapted to apply sufficient torque to wind the print media onto the roll.

9. The apparatus of claim 1, further comprising a gear train which is arranged to be driven by the motor to apply the torque to the roll.

10. A printer comprising the apparatus of claim 1, wherein the printer is arranged to receive print media fed to it from the apparatus or to feed print media to the apparatus.

11. The printer of claim 10, wherein the printer is arranged to removably receive a spindle having roll-based media loaded thereon, and the spindle having a gear adapted to be driven by the motor.

12. The printer of claim 11, wherein the gear of the spindle is adapted to be driven by the motor through a gear transmission that is driven by the motor.

13. A method of controlling tension in roll-based print media, comprising:
detecting an angular displacement of a roll of print media;
determining the radius of the roll of print media based on the detected angular displacement of the roll of print media;
applying a torque to the roll of print media to create tension in the print media; and
controlling the applied torque based on the determined radius of the roll of print media.

14. The method of claim 13, wherein the print media is fed from a roll of print media to a printer.

15. The method of claim 13, wherein the print media is fed from a printer to a roll of print media.

16. The method of claim 13, wherein the step of determining the radius of the roll of print media is further based on a detected angular displacement of a drive roller.

17. The method of claim 13, wherein the torque is controlled by controlling an amount of voltage supplied to a motor.

18. The method of claim 17, wherein the step of controlling an amount of voltage supplied to a motor comprises adjusting the amount of voltage supplied to the motor to compensate for the back electromotive force, EMF, of the motor.

19. The method of claim 18, wherein the motor is a DC motor and the back EMF of the motor is determined based upon the angular speed of the motor.

20. A computer program comprising computer program code means adapted to perform, when run on a computer, the steps of:
detecting an angular velocity of a roll of print media;
determining the radius of the roll of print media based on the detected angular displacement of the roll of print media;
applying a torque to the roll of print media to create tension in the print media; and
controlling the applied torque based on the determined radius of the roll of print media.
